(19) United States
(12) Patent Application Publication
(10) Pub. No.: US 2005/0030616 A1
(43) Pub. Date: Feb. 10, 2005

(54) Observation optical sytem

(76) Inventor: Takaho Matsuda, Tochigi (JP)

Correspondence Address: MORGAN & FINNEGAN, L.L.P., 3 WORLD FINANCIAL CENTER, NEW YORK, NY, 10281-2101, US

(21) Appl. No.: 10/911,169

(22) Filed: Aug. 4, 2004

(30) Foreign Application Priority Data
Aug. 8, 2003 (JP) 2003-206820

(51) Int. Cl. G02B 23/00

(52) U.S. Cl. 359/431; 359/362

(57) ABSTRACT

In an observation optical system having, in order from an object side, an objective optical system, an erect optical system, and an eyepiece optical system, the objective optical system includes, in order from the object side, a first lens unit of a negative refractive power and a second lens unit of a positive refractive power. The second lens unit is a single lens made of a plastic material. This lens is adapted to be rotatably driven about a point on an optical axis as a rotational center, so that the displacement of an image forming position of the objective optical system is executed.

### BACKGROUND OF THE INVENTION

1. Field of the Invention

The present invention relates to an observation optical system, which is, for example, suitable for a telescope and a binocular.

2. Description of the Related Art

Heretofore, in general, an observation device (observation optical equipment) comprising an anti-vibration optical system is known, which compensates the blur of an observation image taken when the observation device is vibrated due to hand shaking.

For example, as an anti-vibration optical system used in an observation optical equipment such as a telescope, a binocular and the like, there has been proposed a configuration having, in order from an object side, an objective lens (objective optical system) consisting of a first lens unit of a positive refracting power, and a second lens unit of a negative refractive power, and an eyepiece (eyepiece optical system) observing an image formed by the objective lens through an image reversal prism (erect optical system), wherein an anti-vibration is executed by driving the second lens unit of the objective lens in a direction orthogonal to an optical axis. (Japanese Patent Application Laid-Open No. 11-264942 (corresponding to: US AA2001055155)).

On the other hand, as the anti-vibration optical system used in the observation optical equipment, there has been also proposed a configuration having, in order from an object side, an objective lens consisting of a first lens unit of a positive refractive power, and a second lens unit of a positive refractive power, and an eyepiece observing an image formed by the objective lens through an image reversal prism, wherein the anti-vibration is executed by driving the second lens unit of the objective lens in a direction orthogonal to an optical axis. (Japanese Patent Application Laid-Open No. 2001-188184).

If an objective optical system used in the observation optical equipment comprising anti-vibration means has a so-called telephoto type lens configuration, such a configuration is characterized in that the whole length of the objective optical system becomes short. On the other hand, the observation optical equipment has the image reversing prism and the like arranged between the objective optical system and the eyepiece optical system, and moreover, requires a space in some degree to arrange an anti-vibration drive mechanism inside the device.

Consequently, even if the objective optical system used in the observation optical equipment which comprises the anti-vibration mechanism is configured by a telephoto type with the whole length of the lens shortened, it is difficult to miniaturize the whole device.

In general, an anti-vibration sensitivity Si where the objective optical system is configured by the first and second lens unit and the second lens unit is driven to execute the-anti vibration is expressed by the following formula by using a magnification β of the second lens unit.
Si=(1−β)

In the lens configuration in which the objective optical system consists of the first and second lens units of the positive and negative refractive powers, the magnification β becomes β>1. Consequently, if the anti-vibration sensitivity Si has to be |Si|>1, β>2 is required, and therefore, this is not that much advantageous in sensitivity wise. If the magnification β is allowed to become much larger in value, though a high sensitivity can be realized, the refractive powers of the lens units of the positive and negative refractive powers have to be increased. Consequently, a large number of lenses are required to correct aberration, which makes the interior of the whole lens system large.

In the lens configuration in which the objective optical system consists of the lens units of the positive refractive powers, compared to a focus length of the objective optical system, the whole length of the lenses of the objective optical system becomes long, so that it is possible to secure a space to arrange the image reversing prism and the like. Besides, a space for arranging an anti-vibration drive mechanism is also easy to secure.

However, as described above, in the configuration having, in order from an object side, an objective lens unit consisting of a first lens unit of a positive refractive power and a second lens unit of a positive refractive power, wherein the anti-vibration is executed by driving the second lens unit in a direction orthogonal to an optical axis, the anti-vibration sensitivity Si at the time of driving the second lens unit is theoretically impossible to be raised not less than 1 as the following formula since the magnification β of the second lens unit is in the scope of 0<β<1.
|Si|=|1−β|<1

Further, in the optical system where a part of the objective optical system is driven to execute the anti-vibration, it is indispensable to make the optical system driven at the time of executing the anti-vibration small in size and light in weight in order to keep the duration of the execution of the anti-vibration long.

### SUMMARY OF THE INVENTION

The object of the present invention is to provide an observation optical system, which secures a space for arranging an erect optical system (image reversing system) and an anti-vibration drive mechanism and, despite of being the objective optical system having a high anti-vibration sensitivity, has an excellent optical performance with a configuration having a small number of lenses, and moreover, can execute the anti-vibration with power saving, which makes it possible to execute the anti-vibration for a long period of time.

An illustrative observation optical system of the present invention is characterized in that, in the observation optical system having, in order from an object side, an objective optical part, an erect optical part, and an eyepiece optical part, the objective optical part has, in order from an object side, a first lens unit of a negative refractive power and a second lens unit of a positive refractive power. The second lens unit consists of a single lens element La made of a plastic material, and this lens element La is adapted to be rotatably driven on the optical axis as a rotational center, thereby performing the displacement of an image forming position of the objective optical part.

### BRIEF DESCRIPTION OF THE DRAWINGS

FIG. 1 is a lens sectional view of an observation optical system of a first embodiment;

FIG. 2 is an aberration view of a normal state of the observation system of the first embodiment;

FIG. 3 is an aberration view of the observation system of the first embodiment at the time of executing the anti-vibration of a field angle of 0.15 degrees;

FIG. 4 is a lens sectional view of the observation optical system of a second embodiment;

FIG. 5 is an aberration view of the normal state of the observation optical system of the second embodiment;

FIG. 6 is an aberration view of the second embodiment at the time of executing the anti-vibration of the field angle of 0.15 degrees;

FIG. 7 is a lens sectional view of the observation optical system of a third embodiment;

FIG. 8 is an aberration view of the normal state of the observation optical system of the third embodiment;

FIG. 9 is an aberration view of the third embodiment at the time of executing the anti-vibration of the field angle of 0.15 degrees; and

FIG. 10 is a schematic diagram of the main components of a telescope.

### DETAILED DESCRIPTION OF THE PREFERRED EMBODIMENTS

Embodiments of an observation optical system of the present invention will be described below with reference to the drawings. The observation optical system described in the following embodiments is suitably used as an optical system of a telescope and a binocular.

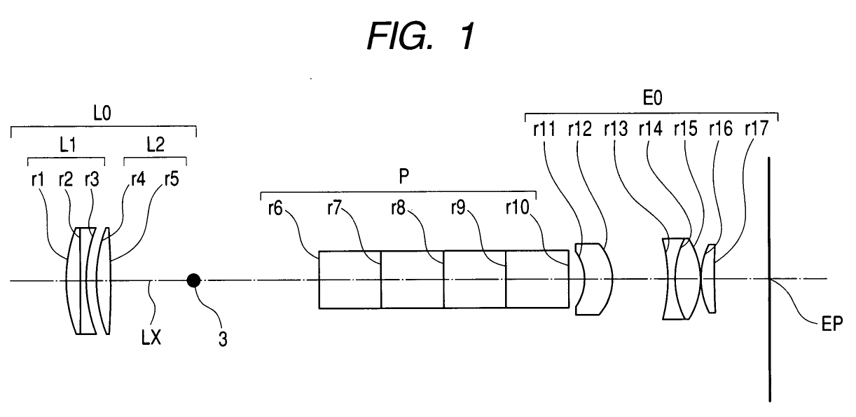

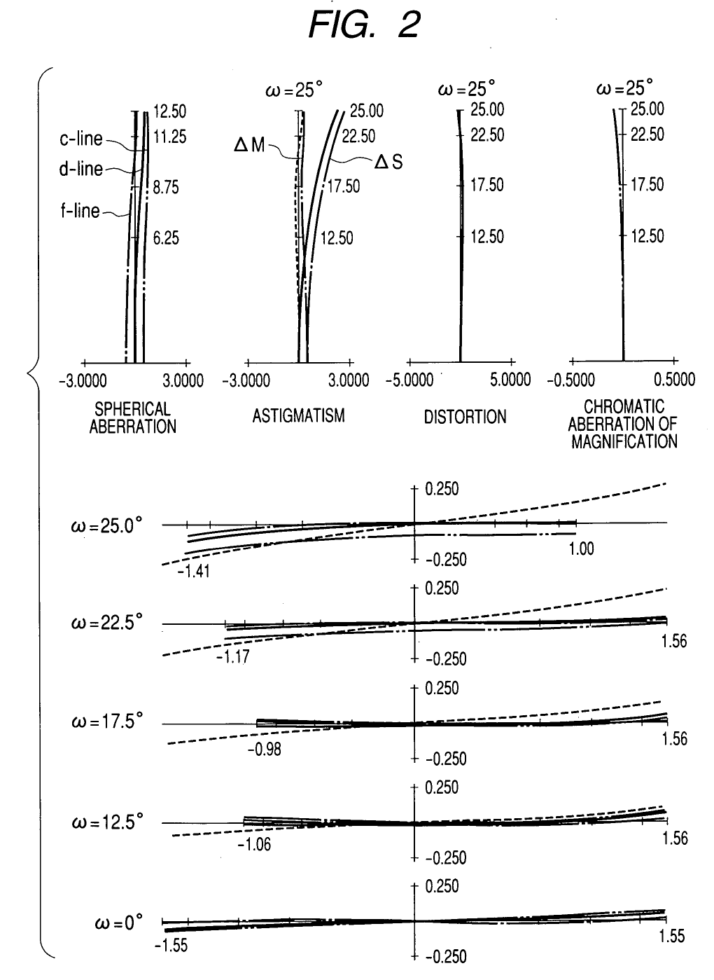

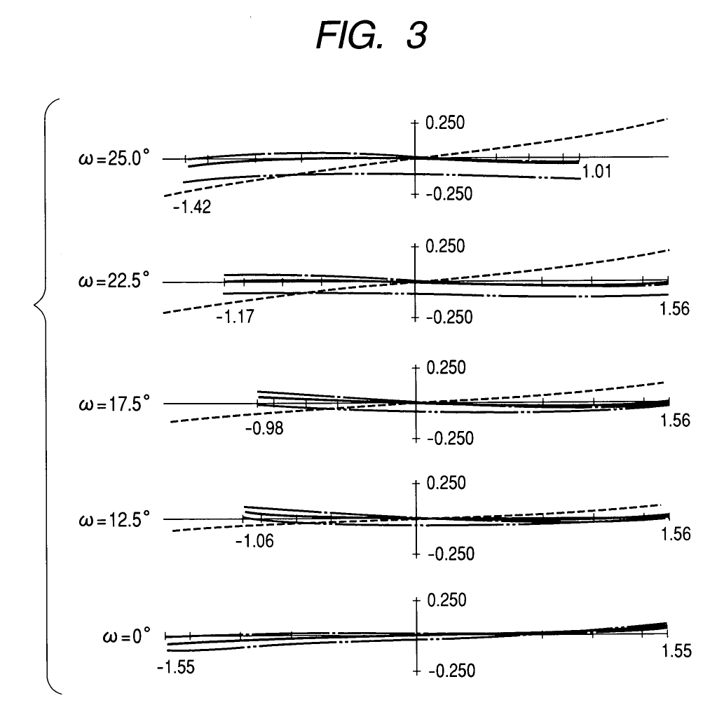

FIG. 1 is a lens sectional view of the observation optical system of the first embodiment, FIG. 2 is a view of various aberrations of the observation optical system of the first embodiment, and FIG. 3 is a view of various aberrations of the observation optical system of the first embodiment at the time of executing the anti-vibration.

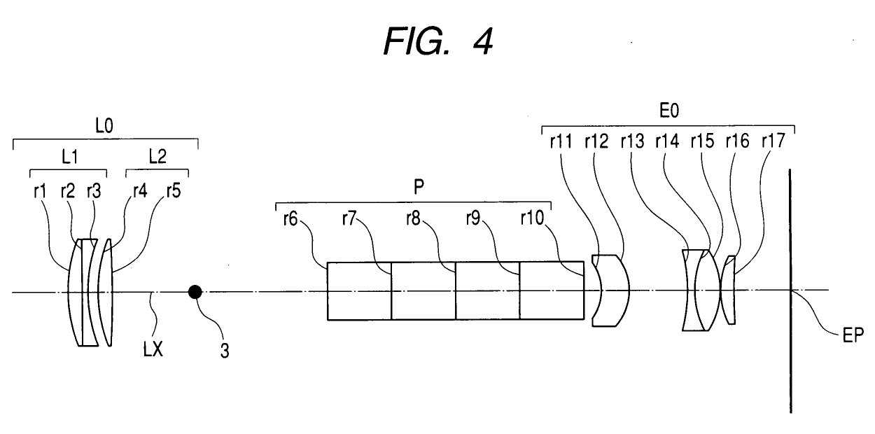

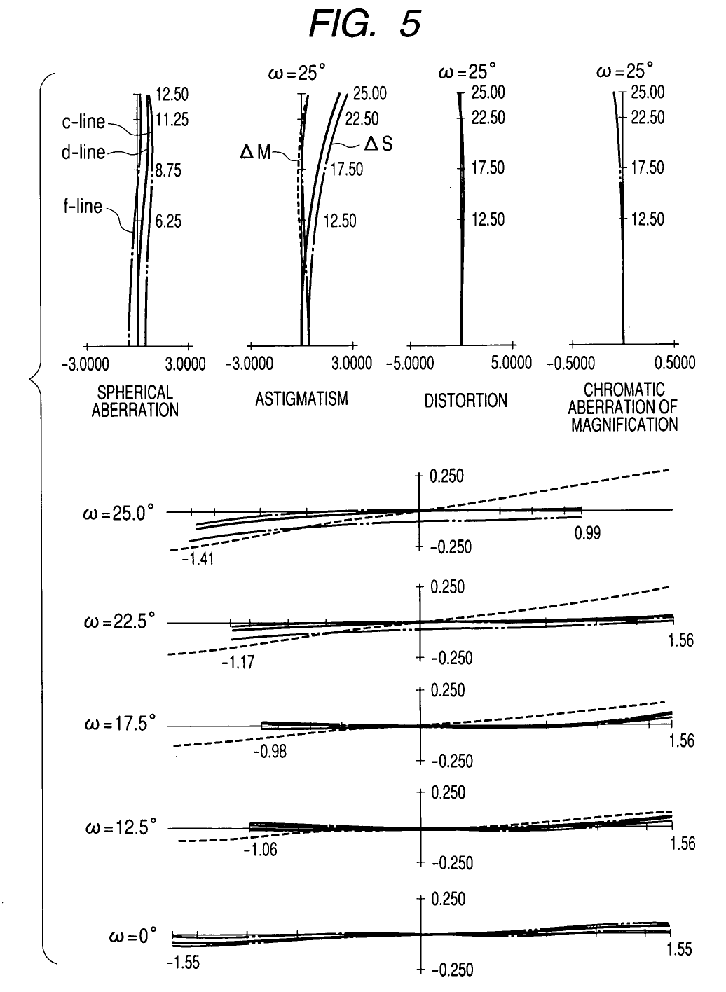

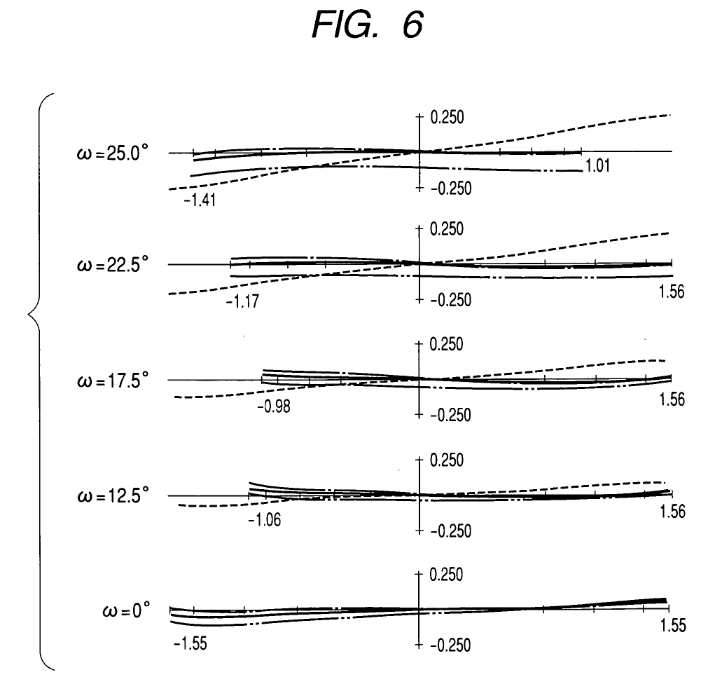

FIG. 4 is a lens sectional view of the observation optical system of the second embodiment, FIG. 5 is a view of various aberrations of the observation optical system of the second embodiment, and FIG. 6 is a view of various aberrations of the observation optical system of the second embodiment at the time of executing the anti-vibration.

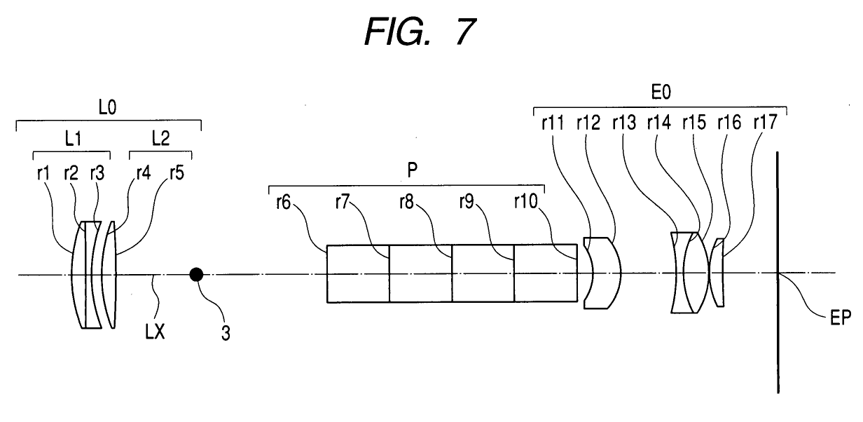

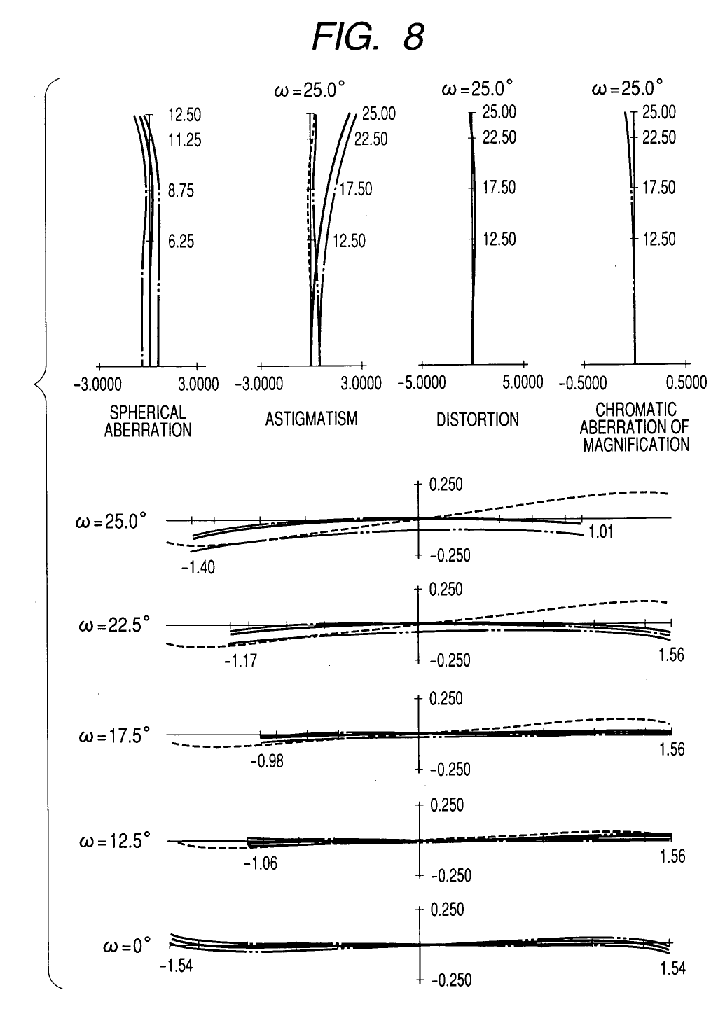

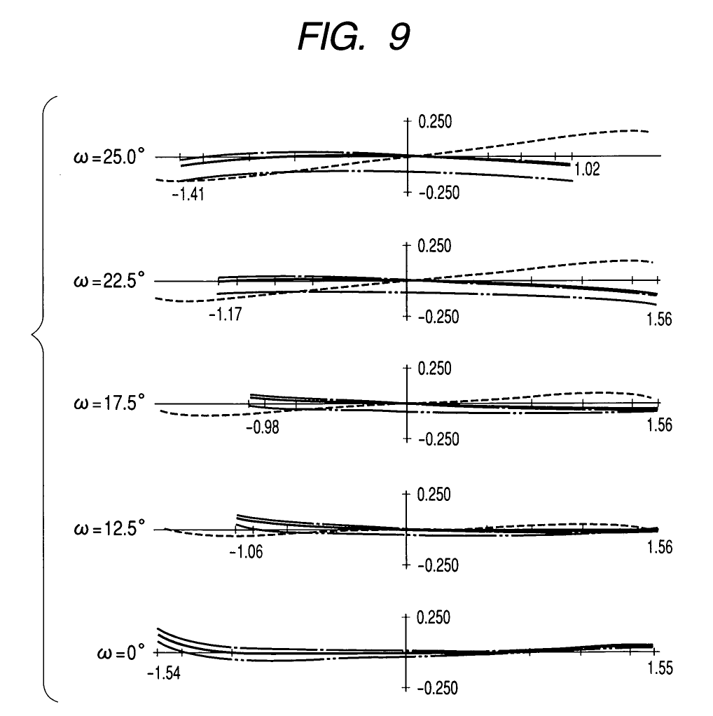

FIG. 7 is a lens sectional view of the observation optical system of the third embodiment, FIG. 8 is a view of various aberrations of the observation optical system of the third embodiment, and FIG. 9 is a view of various aberrations of the observation optical system of the third embodiment at the time of executing the anti-vibration.

The various aberrations at the time of executing the anti-vibration are aberrations (after executing the anti-vibration) after having changed an image position equivalent to 0.15 degrees of an observation field angle (visual field side) of the observation optical system.

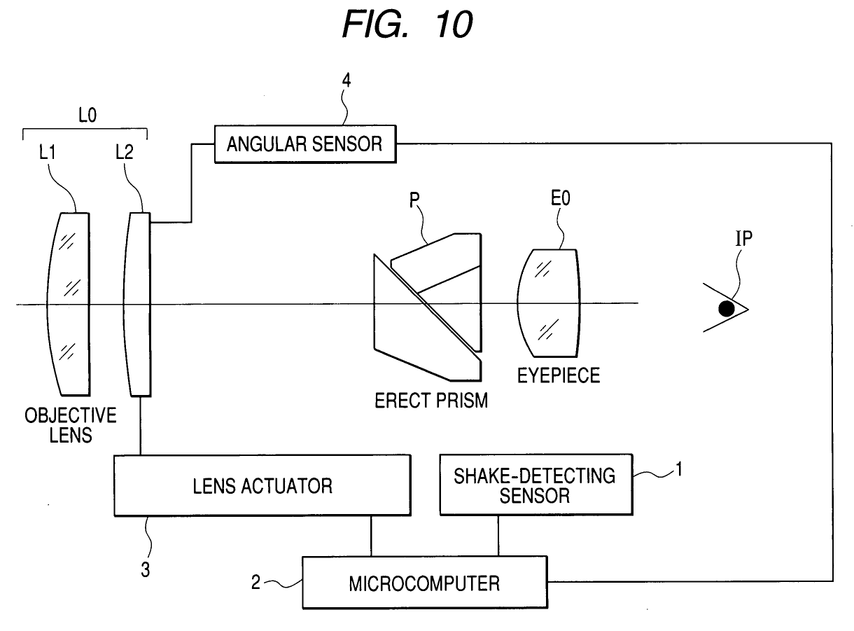

FIG. 10 is a schematic diagram when the observation device is applied to a telescope as the observation device of the present invention.

In the lens sectional views of FIGS. 1, 4, 7, the left side is an object side (observation object side), and the right side is an observer (user) side. Reference character L0 denotes an objective optical system (objective lens). Reference character P denotes an erect optical system (image reversing prism), which converts an observation image (object image) formed by the objective optical system L0 into an erect image.

Reference character E0 denotes an eyepiece optical system (eyepiece). The observer sets his eye in the vicinity of an eye point EP, and observes an observation image of an erect image through the erect optical system P by an eyepiece optical system E0 as a magnified virtual image.

The objective optical system L0 comprises a first lens unit L1 of a negative refractive power (by the term “optical power” is meant an inverse number of a focal length) and a second lens unit L2 of a positive refractive power. Reference numeral 3 denotes a rotational center on an optical axis LX at the time of rotating the second lens unit for the anti-vibration.

The erect optical system P consists of, for example, a porro prism and a pechan roof prism, both of which are well known. In the drawing, the system is shown by a glass block, which expands an optical path.

The objective optical system L0 in each embodiment consists of, in order from the object side, a first lens unit L1 of a negative refractive power and a second lens unit L2 of a positive refractive power. The first lens unit L1 consists of a cemented lens comprising a positive lens and a negative lens, and the second lens unit L2 consists of a single positive refractive power lens La. The rotational drive of the second lens unit L2, with a point 3 on the optical axis taken as a center, executes the anti-vibrations.

By setting up a configuration in this manner wherein the objective optical system L0 consists of the first and second lens units L1 and L2 of negative and positive refractive powers, the whole length of the lens becomes longer than the focal length of the objective optical system L0, thereby easily securing a space to arrange the image reversing prism P. Since the magnification β of the second lens unit L2 becomes β<0, the anti-vibration sensitivity Si becomes as follows.
|Si|=|1−β|>1

Such a configuration is advantageous in the anti-vibration sensitivity, compared to the case where the objective optical system consists of, in order from the object side, the lens units of the positive and negative refractive powers. Further, the single lens of the second lens unit L2 driven for the anti-vibration consists of a plastic, thereby reducing the power consumption at the time of executing the anti-vibration while attempting weight saving.

Further, the first lens unit L1 consists of, in order from the object side, a first lens of a positive refractive power and a second lens of a negative refractive power, and a position of the principal point of the first lens unit L1 is arranged further to the object side than to the whole first lens unit, so that a clearance with the second lens unit L2 is made shorter, thereby attempting a miniaturization. Further, a first lens and a second lens within the first lens unit L1 are made into a cemented lens by being bonded together, and this allows a manufacturing sensitivity of the first lens unit to be lowered and easy to manufacture.

The eyepiece optical system E0 in each embodiment consists of a negative lens of a meniscus shape with its concave surface facing toward the object side, a cemented lens bonding together the negative lens with both of the lens side surface being concave and the positive lens with both of the lens side surface being convex, and a positive lens with the convex surface facing toward the object side.

By setting up such a configuration having three units comprising four pieces of lens, the observation image through the erect optical system P is observed, while maintaining an excellent optical performance.

In each embodiment, where F₀ is taken as a focal length of the whole system of the objective optical system L0, f₁ is taken as a focal length of the first lens unit L1, f₂ is taken as a focal length of the second lens unit L2, D₁₂ is taken as a clearance between the first lens unit L1 and the second lens unit L2, T_{c} is taken as a distance from a surface vertex of the object side of the second lens unit L2 to a rotational center 3, d_{g} is taken as a specific gravity of a lens La, and R₂ is taken as a radius of curvature of the bonded surface of the first lens and the second lens,

$$\begin{matrix}0.1 < \frac{{F}_{0}}{{f}_{1}} < 1.0 & ( 1 ) \\ 1.1 < \frac{{F}_{0}}{{f}_{2}} < 3.0 & ( 2 ) \\ 0.01 < \frac{{D}_{12}}{{F}_{0}} < 0.2 & ( 3 ) \\ 0.1 < \frac{Tc}{{F}_{0}} < 0.7 & ( 4 ) \\ {d}_{g} < 2 & ( 5 ) \\ - 1.85 < \frac{{F}_{0}}{{R}_{2}} < 0.68 & ( 6 )\end{matrix}$$

from among the above conditional formulas, one or more are allowed to be satisfied.

This allows the anti-vibration to be effectively executed, while maintaining an excellent optical performance.

Next, the technical signification of each of the above described conditional formulas will be described.

The conditional formula (1) regulates a ratio of the focal length of the first lens L1 to the focal length of the objective optical system L0. When the refractive power of the first lens unit L1 becomes too weak by crossing over the lower limit, the effect of enlarging the whole length of the objective optical system L0 and the effect of increasing the anti-vibration sensitivity Si are lost. Further, when crossing over the upper limit, the refractive power of the first lens unit L1 becomes too strong, and various aberrations such as a spherical aberration, curvature of field and the like increase, thereby making it difficult to compensate for these aberrations.

The conditional formula (2) regulates a ratio of the focal length of the second lens L2 to the focal length of the objective optical system. When the refractive power of the second lens unit L2 becomes too weak by crossing over the lower limit, the effect of enlarging the whole length of the objective optical system L0 and the effect of increasing the anti-vibration sensitivity Si are lost.

Further, when crossing over the upper limit, the refractive power of the second lens unit L2 becomes too strong, and various aberrations such as a spherical aberration, a curvature of field and the like increase, thereby making it difficult to compensate for these aberrations. Further, when the refractive power of the second lens unit L2 becomes strong, thickness and weight of the lens increase so as to increase an amount of power consumption at the time of executing the anti-vibration drive, and this is not preferable.

The conditional formula (3) regulates a ratio of the clearance between the first lens unit L1 and the second lens unit L2 to the focal length of the objective optical system L0. When crossing over the lower limit, and the first lens unit L1 and the second lens unit L2 approaching too closely, a space for the anti-vibration drive becomes insufficient, thereby causing a possibility of interfering with each other, and this is not preferable.

Further, when crossing over the upper limit, the clearance becomes larger. This causes an effective diameter of the second lens unit L2 to become large so as to allow light beam diverged by the first lens unit L1 to be incident on the second lens unit L2, and thereby increasing the electric power which is required for the anti-vibration drive, and this is not preferable.

The conditional formula (4) regulates the position of the rotational center 3 at the time of rotatably driving the second lens unit L2 with a point on the optical axis taken as the rotational center 3 at the time of executing the anti-vibration, and suitably compensates the aberration generated at the time of executing the anti-vibration, particularly, the generation of an eccentric coma aberration and an eccentric curvature of field. Further, it is preferable that, in view of a mechanical structure, the rotational center is arranged at the image side of the objective optical system L0 and at the object side of the erect optical system P.

When the rotational center 3 approaches the second lens unit L2 by crossing over the lower limit of the conditional formula (4), the compensation of the eccentric aberration becomes excessive, and this is not preferable. Further, a rotation angle required for the drive is increased, thereby complicating the configuration in anti-vibration mechanism, and this is not preferable. On the other hand, when crossing over the upper limit such that the rotational center 3 is positioned away from the second lens unit L2, an aberration compensation effect to be obtained is decreased, compared to a drive mechanism to be configured.

The conditional formula (5) regulates a specific gravity of the single lens La of the second lens unit L2. When crossing over the upper limit, the weight of the lens La driven at the time of executing the anti-vibration results in increasing, thereby increasing the electric power consumption at the time of executing the anti-vibration, and this is not preferable.

The conditional formula (6) regulates a ratio of the radius of curvature of the bonded surface of the first lens and the second lens to the focal length of the objective optical system L0. Regardless of whichever limit of the upper or the lower is crossed over, it is difficult to compensate various aberrations such as the spherical aberration, the curvature of field and the like.

In each of the embodiments, it is more preferable that the scope of the numerical values of the above described conditional formulas from 1 to 6 is set up as follows.

$$\begin{matrix}0.15 < \frac{{F}_{0}}{{f}_{1}} < 0.6 & ( 1 a ) \\ 1.2 < \frac{{F}_{0}}{{f}_{2}} < 2.0 & ( 2 a ) \\ 0.015 < \frac{{D}_{12}}{{F}_{0}} < 0.1 & ( 3 a ) \\ 0.15 < \frac{Tc}{{F}_{0}} < 0.5 & ( 4 a ) \\ {d}_{g} < 1.5 & ( 5 a ) \\ - 0.5 < \frac{{F}_{0}}{{R}_{2}} < 1.0 & ( 6 a )\end{matrix}$$

Next, the numerical data of numerical embodiments 1 to 3 corresponding to each of the embodiments 1 to 3, respectively, will be shown. In each of the numeric embodiments, reference numeral i denotes the order of optical surfaces counted from the object side, reference numeral Ri a radius of curvature of an i-th optical surface (i-th surface), di a clearance between the i-th surface and a (i+1)th surface, and Ndi and νdi an refractive index and an Abbe's number of the material of the i-th optical member on the basis of a d line, respectively.

Surface Nos. 1 to 5 denote the objective optical system L0 and surface Nos. 6 to 10 denote the erect optical system P. Since all of the surfaces which configure the erect optical system P are flat surfaces, the radius of curvature is infinite. Surface Nos. 11 to 17 denote the eyepiece optical system E0.

The surface affixed with [*] from among the surface numbers is a rotationally symmetrical aspherical surface. Presuming that c is taken as a curvature (inverse number of radius of curvature), K as a conic constant, and A4 and A6 as quartic and sixth order aspherical surface coefficients, and a displacement in an optical axis direction at a height y from the optical axis is taken as x on the basis of a surface vertex, the shape of the aspherical surface is represented by
x=cy²/[1+[1−(1+K)c²y²]^{1/2}]+A4y⁴+A6y⁶

Further, the correspondence with the above described formula in each of the numerical embodiments will be shown in Table 1.

Numerical Embodiment 1

| Surface Nos. | R | d | Nd | ν d |
|---|---|---|---|---|
| 1 | 39.15308 | 3 | 1.516330 | 64.14 |
| 2 | 146.15012 | 1.8 | 1.603420 | 38.03 |
| 3 | 34.27542 | 2.7 | — | — |
| 4* | 44.38229 | 3.1 | 1.524700 | 56.20 |
| 5 | −610.63677 | 53.40315 | — | — |
| 6 | ∞ | 16 | 1.568832 | 56.36 |
| 7 | ∞ | 16 | 1.568832 | 56.36 |
| 8 | ∞ | 16 | 1.568832 | 56.36 |
| 9 | ∞ | 16 | 1.568832 | 56.36 |
| 10 | ∞ | 4.07043 | — | — |
| 11 | −11.61171 | 7 | 1.696797 | 55.53 |
| 12 | −12.78941 | 14.10376 | — | — |
| 13 | −44.37906 | 1.61553 | 1.846660 | 23.78 |
| 14 | 21.05366 | 6.66885 | 1.712995 | 53.87 |
| 15 | −17.25151 | 0.2 | — | — |
| 16 | 17.85659 | 3.50624 | 1.696797 | 55.53 |
| 17 | 185.29566 | 13.5 | — | — |

*shows a rotationally symmetrical aspherical surface

Aspherical data (unrepresented aspherical surface coefficient is 0.00)

| Surface | | | |
|---|---|---|---|
| No. | K | A4 | A6 |
| 4 | 0.337297 × 10⁻³ | −0.97774 × 10⁻⁹ | 0.148891 × 10⁻¹¹ |

A distance from the surface No. 4 to the rotational center: 25 mm.

Numerical Embodiment 2

| Surface Nos. | R | D | Nd | ν d |
|---|---|---|---|---|
| 1 | 39.09171 | 3 | 1.516330 | 64.14 |
| 2 | 147.93702 | 1.8 | 1.603420 | 38.03 |
| 3 | 34.09653 | 2.7 | — | — |
| 4* | 44.10516 | 3.2 | 1.524700 | 56.20 |
| 5* | −612.87118 | 53.40315 | — | — |
| 6 | ∞ | 16 | 1.568832 | 56.36 |
| 7 | ∞ | 16 | 1.568832 | 56.36 |
| 8 | ∞ | 16 | 1.568832 | 56.36 |
| 9 | ∞ | 16 | 1.568832 | 56.36 |
| 10 | ∞ | 4.07043 | — | — |
| 11 | −11.61171 | 7 | 1.696797 | 55.53 |
| 12 | −12.78941 | 14.10376 | — | — |
| 13 | −44.37906 | 1.61553 | 1.846660 | 23.78 |
| 14 | 21.05366 | 6.66885 | 1.712995 | 53.87 |
| 15 | −17.25151 | 0.2 | — | — |
| 16 | 17.85659 | 3.50624 | 1.696797 | 55.53 |
| 17 | 185.29566 | 13.5 | — | — |

*shows a rotationally symmetrical aspherical surface

Aspherical data (unrepresented aspherical surface coefficient is 0.00)

| Surface | | | |
|---|---|---|---|
| Nos. | K | A4 | A6 |
| 4 | −0.295644 | 0.111855 × 10⁻⁵ | 0.209567 × 10⁻⁸ |
| 5 | 0.170526 × 10³ | 0.848671 × 10⁻⁶ | 0.160168 × 10⁻⁸ |

A distance from the surface No. 4 to the rotational center: 25 mm.

Numerical Embodiment 3

| Surface Nos. | R | d | Nd | ν d |
|---|---|---|---|---|
| 1 | 39.06685 | 3 | 1.516330 | 64.14 |
| 2 | 156.39363 | 1.8 | 1.603420 | 38.03 |
| 3 | 35.85155 | 2.7 | — | — |
| 4* | 44.25367 | 3.1 | 1.491710 | 57.40 |
| 5* | −602.55379 | 53.40315 | — | — |
| 6 | ∞ | 16 | 1.568832 | 56.36 |
| 7 | ∞ | 16 | 1.568832 | 56.36 |
| 8 | ∞ | 16 | 1.568832 | 56.36 |
| 9 | ∞ | 16 | 1.568832 | 56.36 |
| 10 | ∞ | 4.07043 | — | — |
| 11 | −11.61171 | 7 | 1.696797 | 55.53 |
| 12 | −12.78941 | 14.10376 | — | — |
| 13 | −44.37906 | 1.61553 | 1.846660 | 23.78 |
| 14 | 21.05366 | 6.66885 | 1.712995 | 53.87 |
| 15 | −17.25151 | 0.2 | — | — |
| 16 | 17.85659 | 3.50624 | 1.696797 | 55.53 |
| 17 | 185.29566 | 13.5 | — | — |

*shows a rotationally symmetrical aspherical surface

Aspherical data (unrepresented aspherical surface coefficient is 0.00)

| Surface | | | |
|---|---|---|---|
| Nos. | K | A4 | A6 |
| 4 | −0.32726 × 10⁻³ | 0.233035 × 10⁻⁷ | 0.276981 × 10⁻¹⁰ |
| 5 | 0.315791 × 10³ | 0.265597 × 10⁻⁷ | 0.216952 × 10⁻¹⁰ |

A distance from the surface No. 4 to the rotational center: 25 mm.

TABLE 1

| | Numerical | Numerical | Numerical |
|---|---|---|---|
| | Embodiment 1 | Embodiment 2 | Embodiment 3 |
| Conditional | 0.339776 | 0.3479979 | 0.260055 |
| Formula (1) | | | |
| Conditional | 1.385114 | 1.393378 | 1.305568 |
| Formula (2) | | | |
| Conditional | 0.02468 | 0.02467 | 0.024628 |
| Formula (3) | | | |
| Conditional | 0.228517 | 0.228426 | 0.22804 |
| Formula (4) | | | |
| Conditional | 1.01 | 1.01 | 1.19 |
| Formula (5) | | | |
| Conditional | 1.335912 | 1.351704 | 1.426559 |
| Formula (6) | | | |

FIG. 10 is a schematic diagram of main components when the observation optical system of the present invention is applied to a telescope.

In FIG. 10, a shake-detecting sensor 1 is a vibration gyro-sensor, which consists of a pitching shake-detecting sensor for detecting a vertical shake and a yawing shake-detecting sensor for detecting a horizontal shake, and the two sensors are configured by orthogonalizing sensitivity shafts. The shake-detecting sensor 1 detects an angular acceleration and outputs the information to a microcomputer 2 as a signal.

When the microcomputer 2 receives information about a shake (angular acceleration) from the shake-detecting sensor 1, it calculates an angle of rotational movement of the second lens unit L2 so as to output it to a lens actuator 3.

The lens actuator 3 allows the second lens unit L2 to rotatably drive or drive so as to have a component in a direction vertical to the optical axis based on the signal from the microcomputer 2.

An angler sensor 4 measures the angle of rotational movement of the second lens unit L2 and outputs it to the microcomputer 2, and when this output matches the value obtained by the calculation, the microcomputer 2 controls the drive of the lens actuator 3 so as to stop it. By so doing, the anti-vibration is executed.

This application claims priority from Japanese Patent Application No. 2003-206820 filed Aug. 8, 2003, which is hereby incorporated by reference herein.

1. An observation optical system, comprising, in order from an object side,
an objective optical part comprising, in order from an object side,
a first lens unit of a negative optical power; and
a second lens unit of a positive optical power;
the second lens unit consisting of a single lens element La made of a plastic material, wherein the lens element La rotates about a point on an optical axis as a rotational center, so that a displacement of an image forming position of said objective optical part is executed;
an erect optical part; and
an eyepiece optical part.

2. The observation optical system according to claim 1, wherein said first lens unit has, in order from the object side, a first lens element of a positive refractive power and a second lens element of a negative refractive power.

3. The observation optical system according to claim 2, wherein said first lens element and second lens element are bonded together so as to configure a cemented lens.

4. The observation optical system according to claim 1, wherein said lens element La is an aspherical surface lens.

5. The observation optical system according to claim 1, satisfying the following condition:
0.1<F₀/f₁<1.0
where F₀ is a focal length of the whole system of said objective optical system, and f₁ is a focal length of said first lens unit.

6. The observation optical system according to claim 1, satisfying the following condition:
1.1<F₀/f₂<3.0
where F₀ is a focal length of the whole system of said objective optical system, and f₂ is the focal length of said second lens unit.

7. The observation optical system according to claim 1, satisfying the following condition:
0.01<D₁₂/F₀<0.2
where F₀ is a focal length of the whole system of said objective optical system, and D₁₂ is a clearance between said first lens unit and second lens unit.

8. The observation optical system according to claim 1, satisfying the following condition:
0.1<Tc/F₀<0.7
where F₀ is a focal length of the whole system of said objective optical system, and Tc is a distance from the surface vertex of the object side of said second lens unit to said rotational center.

9. The observation optical system according to claim 1, satisfying the following condition:
d_{g}<2
where d_{g} is a specific gravity of said lens element La.

10. The observation optical system according to claim 3, satisfying the following condition:
−1.85<F₀/R₂<0.68
where F₀ is a focal length of the whole system of said objective optical system, and R₂ is a radius of curvature of the bonded surface of said first lens element and said second lens element.
